(19) United States
(12) Patent Application Publication
(10) Pub. No.: US 2017/0105071 A1
(43) Pub. Date: Apr. 13, 2017

(54) Sound Channel Configuration Method and Apparatus and Earphone Device

(71) Applicant: Beijing Zhigu Rui Tuo Tech Co., Ltd, Beijing (CN)

(72) Inventor: Ran XU, Beijing (CN)

(21) Appl. No.: 15/129,418

(22) PCT Filed: Dec. 29, 2014
(86) PCT No.: PCT/CN2014/095261

§ 371 Date: Sep. 26, 2016

(30) Foreign Application Priority Data
Apr. 2, 2014 (CN) 201410130968.6

(51) Int. Cl. H04R 5/04; H04R 29/00; H04R 1/10; H04R 5/033

(52) U.S. Cl. CPC H04R 5/04; H04R 5/033; H04R 29/001; H04R 1/1091

(57) ABSTRACT

Embodiments of the present application provide a sound channel configuration method and apparatus and an earphone device. The method includes: obtaining heartbeat transmission signals at two earpieces in pair; and performing sound channel configuration on signals of the two earpieces at least according to the heartbeat transmission signals at the two earpieces. The embodiments of the present application provide sound channel configuration solutions.

### RELATED APPLICATION

The present international patent cooperative treaty (PCT) application claims the benefit of priority to Chinese Patent Application No. 201410130968.6, filed on Apr. 2, 2014, and entitled “Sound Channel Configuration Method and Apparatus and Earphone Device”, which is hereby incorporated into the present international PCT application by reference herein in its entirety.

### TECHNICAL FIELD

The present application relates to the field of signal processing technologies, and in particular, to a sound channel configuration method and apparatus and an earphone device.

### BACKGROUND

A conventional earphone device generally includes two earpieces in pair, where one is a left earpiece and the other is a right earpiece; and sound channels of signals of the left earpiece and the right earpiece are respectively a left sound channel and a right sound channel. In order to distinguish the left earpiece and the right earpiece, a letter L indicating left and a letter R indicating right are generally printed on the two earpieces separately or shapes of the two earpieces are separately designed to be suitable for a left ear or a right ear.

Even so, a user may still wear the left earpiece and the right earpiece oppositely, leading to poor experience of earpiece signals.

### SUMMARY

An example objective of an embodiment of the present application is to provide sound channel configuration solutions.

In order to achieve the foregoing objective, according to an example aspect of the embodiment of the present application, a sound channel configuration method is provided, including:
obtaining heartbeat transmission signals at two earpieces in pair; and
performing sound channel configuration on signals of the two earpieces at least according to the heartbeat transmission signals at the two earpieces.

In order to achieve the foregoing objective, according to another example aspect of the embodiment of the present application, a sound channel configuration apparatus is provided, including:
an obtaining module, for obtaining heartbeat transmission signals at two earpieces in pair; and
a configuration module, for performing sound channel configuration on signals of the two earpieces at least according to the heartbeat transmission signals at the two earpieces.

In order to achieve the foregoing objective, according to still another example aspect of the embodiment of the present application, an earphone device is provided, including: two earpieces in pair and the sound channel configuration apparatus as described above.

At least one technical solution in the foregoing technical solutions has the following example beneficial effects:

One embodiment of the present application provides a sound channel configuration solution by obtaining heartbeat transmission signals at two earpieces in pair, and performing sound channel configuration on signals of the two earpieces at least according to the heartbeat transmission signals at the two earpieces.

### BRIEF DESCRIPTION OF THE DRAWINGS

FIG. 1a is an example schematic flowchart of an embodiment of a sound channel configuration method according to the present application;

FIG. 1b is an example simplified schematic diagram of electrocardiographic waveforms at the two earpieces;

FIG. 2 is an example schematic structural diagram of an embodiment of a sound channel configuration apparatus according to the present application;

FIG. 3a is an example schematic structural diagram of an embodiment of an earphone device according to the present application; and

FIG. 3b is an example schematic structural diagram of an implementation manner of the embodiment shown in FIG. 3a.

### DETAILED DESCRIPTION

Embodiments of the present application are further described in detail hereinafter with reference to the accompanying drawings and embodiments. The following embodiments are intended to describe the present application, but not to limit the scope of the present application.

FIG. 1a is a schematic flowchart of an embodiment of a sound channel configuration method according to the present application. As shown in FIG. 1a, this embodiment includes:

101: Obtain heartbeat transmission signals at two earpieces in pair.

For example, a sound channel configuration apparatus provided by the present application carries out this embodiment, that is, the sound channel configuration apparatus obtains the heartbeat transmission signals at the two earpieces in pair. Specifically, the sound channel configuration apparatus can be disposed in an earphone device or an audio output device in a software manner, a hardware manner, or a manner of a combination of software and hardware. The earphone device may be a wireless earphone device, that is, the earphone device is capable of exchanging signals with an audio output device in a wireless manner; the earphone device may also be a wired earphone device, that is, the earphone device is capable of exchanging signals with an audio output device in a wired manner. The audio output device may be a device capable of outputting audio, such as a mobile phone, a tablet computer, or an MP3 player, and the audio output device is capable of exchanging signals with the two earpieces in a wireless or wired manner.

Each one of the heartbeat transmission signals in this embodiment is a signal changing with a heartbeat. Specifically, each one of the heartbeat transmission signals includes but is not limited to at least one of the following: an electrocardiographic waveform and a blood flow pulsation waveform. Specifically, each one of the heartbeat transmission signals can be acquired by a corresponding biometric sensor. For example, an electrocardiographic waveform can be acquired by an electrocardiogram (ECG) sensor, and a blood flow pulsation waveform can be acquired by a photoplethysmography (or photoplethysmogram, PPG) sensor.

102: Perform sound channel configuration on signals of the two earpieces at least according to the heartbeat transmission signals at the two earpieces.

Specifically, the performing sound channel configuration on signals of the two earpieces includes: separately configuring sound channels of the signals of the two earpieces as a left sound channel and a right sound channel. There are many manners to separately configure sound channels of the signals of the two earpieces as a left sound channel and a right sound channel. For example, when the channel configuration apparatus is disposed in the earphone device, the choice of an input sound channel can be implemented on the basis of a default input sound channel configuration of signals and a sound channel switching circuit, thereby different sound channel configurations implemented. For example, when the sound channel configuration apparatus is disposed in an audio output device, the choice of an output sound channel can be implemented on the basis of a default output sound channel configuration of signals and a sound channel switching circuit, thereby different sound channel configurations implemented. Alternatively, different sound channel configurations can be implemented by interchanging content of signals.

Because a heartbeat passes different paths to be transmitted from the heart to a left ear and to a right ear, a difference correspondingly exists between a heartbeat transmission signal of an earpiece located at the left ear and a heartbeat transmission signal of an earpiece located at the right ear. On the basis of the difference, it can be determined which earpiece is located at the left ear and which earpiece is located at the right ear, thereby performing corresponding sound channel configuration.

In an optional embodiment, the performing sound channel configuration on signals of the two earpieces at least according to the heartbeat transmission signals at the two earpieces includes:
comparing the heartbeat transmission signals at the two earpieces, configuring a sound channel of the signal of the earpiece corresponding to the heartbeat transmission signal whose crest appears earlier in a same signal period as a left sound channel, and configuring a sound channel of the signal of the earpiece corresponding to the heartbeat transmission signal whose crest appears later in the same signal period as a right sound channel.

Generally, the heart of a human body is located at a left side of a human body, so that a path in which the heartbeat is transmitted from the heart to the left ear is shorter than a path in which the heartbeat is transmitted to the right ear; and correspondingly a crest of the heartbeat transmission signal of the earpiece located at the left ear appears earlier than a crest of the heartbeat transmission signal of the earpiece located at the right ear.

FIG. 1b is a simplified schematic diagram of electrocardiographic waveforms at the two earpieces. As shown in FIG. 1b, ECG1 is an electrocardiographic waveform at an earpiece, and ECG2 is an electrocardiographic waveform at the other earpiece. In a same signal period T, the crest of ECG1 appears earlier than that of ECG2; therefore, it can be determined that the earpiece corresponding to ECG1 is located at the left ear and the earpiece corresponding to ECG2 is located at the right ear. A time interval between the crest of ECG1 and the crest of ECG2 is Δt, and Δt/T is generally less than 0.5.

This embodiment provides a sound channel configuration solution by obtaining heartbeat transmission signals at two earpieces in pair, and performing sound channel configuration on signals of the two earpieces at least according to the heartbeat transmission signals at the two earpieces.

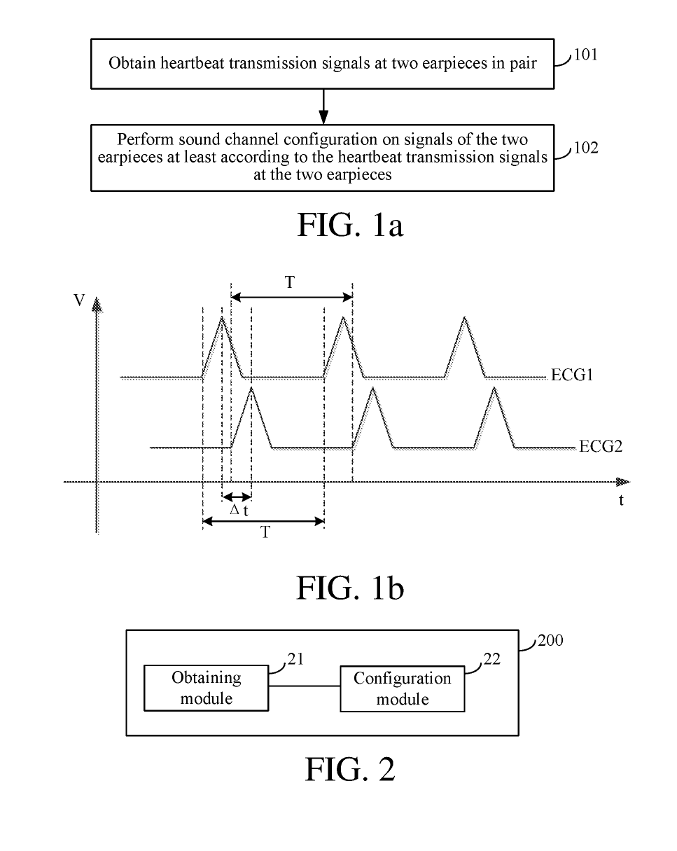

FIG. 2 is a schematic structural diagram of an embodiment of a sound channel configuration apparatus according to the present application. As shown in FIG. 2, the sound channel configuration apparatus (referred to as the apparatus for short hereinafter) 200 includes:
an obtaining module 21, for obtaining heartbeat transmission signals at two earpieces in pair;
a configuration module 22, for performing sound channel configuration on signals of the two earpieces at least according to the heartbeat transmission signals at the two earpieces.

Each one of the heartbeat transmission signals in this embodiment is a signal changing with a heartbeat. Specifically, each one of the heartbeat transmission signal includes but is not limited to at least one of the following: an electrocardiographic waveform and a blood flow pulsation waveform.

Specifically, the performing sound channel configuration on signals of the two earpieces by the configuration module 22 includes: separately configuring, by the configuration module 22, sound channels of the signals of the two earpieces as a left sound channel and a right sound channel. There are many manners for the configuration module 22 to separately configure sound channels of the signals of the two earpieces as a left sound channel and a right sound channel. For example, while the apparatus 200 is disposed in an earphone device, the choice of an input sound channel can be implemented by the configuration module 22 on the basis of a default sound channel configuration of signals and a sound channel switching circuit, thereby different sound channel configurations implemented. When the apparatus 200 is disposed in an audio output device, the choice of an output sound channel can be implemented by the configuration module 22 on the basis of a default output sound channel configuration of signals and a sound channel switching circuit, thereby different sound channel configurations implemented. Alternatively, different channel configurations can be implemented by interchanging content of signals.

Because a heartbeat passes different paths to be transmitted from the heart to a left ear and to a right ear, a difference correspondingly exists between a heartbeat transmission signal, obtained by the obtaining module 21, of an earpiece located at the left ear and a heartbeat transmission signal, obtained by the obtaining module 21, of an earpiece located at the right ear. On the basis of the difference, the configuration module 22 can determine which earpiece is located at the left ear and which earpiece is located at the right ear, thereby performing corresponding sound channel configuration.

In an optional embodiment, the configuration module 22 is further configured to:
compare the heartbeat transmission signals at the two earpieces, and configure a sound channel of the signal of the earpiece corresponding to the heartbeat transmission signal whose crest appears earlier in a same signal period as a left sound channel, and configure a sound channel of the signal of the earpiece corresponding to the heartbeat transmission signal whose crest appears later in the same signal period as a right sound channel.

Generally, the heart of a human body is located at a left side of a human body, so that a path in which the heartbeat is transmitted from the heart to the left ear is shorter than a path in which the heartbeat is transmitted to the right ear; and correspondingly a crest of the heartbeat transmission signal of the earpiece located at the left ear appears earlier than a crest of the heartbeat transmission signal of the earpiece located at the right ear. Using electrocardiographic waveforms as an example, as shown in FIG. 1b, ECG1 is an electrocardiographic waveform, obtained by the obtaining module 21, at an earpiece, and ECG2 is an electrocardiographic waveform, obtained by the obtaining module 21, at the other earpiece. In a same signal period T, a crest of ECG1 appears earlier than that of ECG2; therefore, the configuration module 22 can determine that the earpiece corresponding to ECG1 is located at the left ear and the earpiece corresponding to ECG2 is located at the right ear. A time interval between the crest of ECG1 and the crest of ECG2 is Δt, and Δt/T is generally less than 0.5.

Specifically, each one of the heartbeat transmission signal can be acquired by a corresponding biometric sensor; correspondingly, the obtaining module 21 obtains each one of the heartbeat transmission signals from a corresponding biometric sensor.

In an optional embodiment, each one of the heartbeat transmission signal includes: an electrocardiographic waveform. Optionally, the obtaining module 21 is further configured to: obtain electrocardiographic waveforms at the two earpieces from ECG sensors separately disposed at the two earpieces, where each earpiece can be provided with at least one ECG sensor. For example, when one earpiece is provided with only one ECG sensor, the obtaining module 21 regards an electrocardiographic waveform obtained from the ECG sensor as the electrocardiographic waveform at the earpiece; when one earpiece is provided with multiple ECG sensors, the obtaining module 21 can perform a mean treatment on electrocardiographic waveforms obtained from the multiple ECG sensors, that is, the obtaining module 21 calculates the mean of values of points corresponding to the same time in the multiple electrocardiographic waveforms, and regards an electrocardiographic waveform obtained by the treatment as the electrocardiographic waveform at the earpiece.

In another optional embodiment, each one of the heartbeat transmission signals includes: a blood flow pulsation waveform. Optionally, the obtaining module 21 is further configured to: obtain blood flow pulsation waveforms at the two earpieces from PPG sensors separately disposed at the two earpieces, where each earpiece can be provided with at least one PPG sensor. For example, when one earpiece is provided with only one PPG sensor, the obtaining module 21 regards a blood flow pulsation waveform obtained from the PPG sensor as the blood flow pulsation waveform at the earpiece; when one earpiece is provided with multiple PPG sensors, the obtaining module 21 can perform a mean treatment on blood flow pulsation waveforms obtained from the multiple PPG sensors, that is, the obtaining module 21 calculates the mean of values of points corresponding to the same time in the multiple blood flow pulsation waveforms, and regards a blood flow pulsation waveform obtained by the treatment as the blood flow pulsation waveform at the earpiece.

Specifically, the apparatus 200 can be implemented in a software manner, a hardware manner, or a manner of a combination of software and hardware, and may be disposed in various devices.

In one possible scenario, the apparatus 200 and the two earpieces are disposed together in one earphone device. The earphone device may be a wireless earphone device, that is, the earphone device is capable of exchanging signals with an audio output device in a wireless manner; the earphone device may also be a wired earphone device, that is, the earphone device is capable of exchanging signals with an audio output device in a wired manner.

In another possible scenario, the apparatus 200 is disposed in an audio output device providing the signals for the two earpieces, where the audio output device may be a device capable of outputting audio, such as a mobile phone, a tablet computer, or an MP3 player, and the audio output device is capable of exchanging signals with the two earpieces in a wireless or wired manner.

This embodiment provides a sound channel configuration solution by obtaining heartbeat transmission signals at two earpieces in pair, and performing sound channel configuration on signals of the two earpieces at least according to the heartbeat transmission signals at the two earpieces.

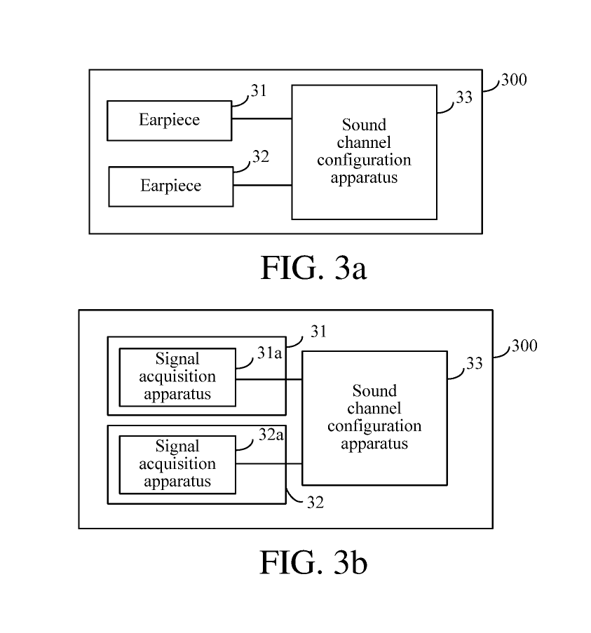

FIG. 3a is a schematic structural diagram of an embodiment of an earphone device according to the present application. As shown in FIG. 3a, the earphone device (referred to as the device for short hereinafter) 300 includes: two earpieces 31, 32 in pair and a sound channel configuration apparatus 33, where the sound channel configuration apparatus 33 is the apparatus 200 as described in the embodiment of a sound channel configuration apparatus according to the present application.

In an optional embodiment, as shown in 3b, the device 300 further includes: signal acquisition apparatuses 31a, 32a separately disposed in the two earpieces 31, 32, where each of the two earpieces 31, 32 is provided with at least one of the signal acquisition apparatuses 31a, 32a. The at least one signal acquisition apparatus 31a, 32a is configured to separately acquire a heartbeat transmission signal, where the at least one signal acquisition apparatus 31a is configured to acquire a heartbeat transmission signal at the earpiece 31, and the at least one signal acquisition apparatus 32a is configured to acquire a heartbeat transmission signal at the earpiece 32. It should be noted that the signal acquisition apparatus 31a may also be disposed outside the earpiece 31, for example, disposed near the earpiece 31, and the signal acquisition apparatus 32a may also be disposed outside the earpiece 32, for example, disposed near the earpiece 32, which are not limited hereto by this embodiment.

Optionally, the at least one signal acquisition apparatus 31a, 32a comprises at least one of the following: at least one ECG sensor and at least one PPG sensor, wherein, each one of the at least one ECG sensor can be configured to acquire an electrocardiographic waveform, and each one of the at least one PPG sensor can be configured to acquire a blood flow pulsation waveform.

Because the sound channel configuration apparatus 33 needs to compare the heartbeat transmission signals at the two earpieces, the heartbeat transmission signals for comparison should be of the same type, and correspondingly, the at least one signal acquisition apparatus 31a, 32a at the two earpieces (31, 32) should also include the same type signal acquisition apparatus. For example, the at least one signal acquisition apparatus 31a includes at least one ECG sensor, and the at least one signal acquisition apparatus 32a also includes at least one ECG sensor.

It should be noted that the device 300 may be a wireless earphone device, that is, the device is capable of exchanging signals with an audio output device in a wireless manner, and may also be a wired earphone device, that is, the device is capable of exchanging signals with an audio output device in a wired manner.

This embodiment provides a sound channel configuration solution by obtaining heartbeat transmission signals at two earpieces in pair, and performing sound channel configuration on signals of the two earpieces at least according to the heartbeat transmission signals at the two earpieces.

It can be realized by a person of ordinary skill in the art that, units and method steps described with reference to the embodiments disclosed in this specification can be implemented by electronic hardware or a combination of computer software and electronic hardware. Whether these functions are actually executed in a hardware or software form depends on specific applications and design constraints of the technical solution. A person skilled in the art may use different methods to implement the described function for each specific application, but such implementation should not be considered beyond the scope of the present application.

If the function is implemented in a form of a software functional unit and is sold or used as an independent product, the product can be stored in a computer-readable storage medium. Based on this understanding, the technical solution of the present application essentially, or a part, of the technical solution, that contributes to the prior art, or a part of the technical solution may be embodied in a form of a software product; the computer software product is stored in a storage medium and includes a number of instructions that enable a computer device (which may be a personal computer, a server, a network device, or the like) to execute all or some of the steps of the method in the embodiments of the present application. The foregoing storage medium includes all kinds of mediums that can store program code, such as a USB flash drive, a mobile hard disk, a read-only memory (ROM), a random access memory (RAM), a magnetic disk, or a compact disc.

The foregoing embodiments are only used to describe the present application, but not to limit the present application. A person of ordinary skill in the art can still make various alterations and modifications without departing from the spirit and scope of the present application; therefore, all equivalent technical solutions also fall within the scope of the present application, and the patent protection scope of the present application should be subject to the claims.

What is claimed is:

1. A method, comprising:
obtaining, by a device comprising a processor, heartbeat transmission signals at two earpieces in pair; and
performing sound channel configuration on signals of the two earpieces at least according to the heartbeat transmission signals at the two earpieces.

2. The method of claim 1, wherein each one of the heartbeat transmission signals comprises at least one of an electrocardiographic waveform or a blood flow pulsation waveform.

3. The method of claim 1, wherein the performing the sound channel configuration on the signals comprises:
comparing the heartbeat transmission signals at the two earpieces, configuring a first sound channel of a first signal of a first earpiece corresponding to a first heartbeat transmission signal whose crest appears earlier in a same signal period as a left sound channel, and configuring a second sound channel of a second signal of a second earpiece corresponding to a second heartbeat transmission signal whose crest appears later in a same signal period as a right sound channel.

4. The method of claim 2, wherein the performing the sound channel configuration on the signals comprises:
comparing the heartbeat transmission signals at the two earpieces, configuring a first sound channel of a first signal of a first earpiece corresponding to a first heartbeat transmission signal whose crest appears earlier in a same signal period as a left sound channel, and configuring a second sound channel of a second signal of a second earpiece corresponding to a second heartbeat transmission signal whose crest appears later in a same signal period as a right sound channel.

5. An apparatus, comprising:
a processor, coupled to a memory, that executes or facilitates execution of executable modules, comprising:
an obtaining module configured to obtain heartbeat transmission signals at two earpieces in pair; and
a configuration module configured to perform sound channel configuration on signals of the two earpieces at least according to the heartbeat transmission signals at the two earpieces.

6. The apparatus of claim 5, wherein the configuration module is further configured to:
compare the heartbeat transmission signals at the two earpieces, and configure a first sound channel of a first signal of a first earpiece corresponding to a first heartbeat transmission signal whose crest appears earlier in a same signal period as a left sound channel, and configure a second sound channel of a second signal of a second earpiece corresponding to a second heartbeat transmission signal whose crest appears later in a same signal period as a right sound channel.

7. The apparatus of claim 5, wherein each one of the heartbeat transmission signals comprises: an electrocardiographic waveform.

8. The apparatus of claim 6, wherein each one of the heartbeat transmission signals comprises: an electrocardiographic waveform.

9. The apparatus of claim 7, wherein the obtaining module is further configured to: obtain electrocardiographic waveforms at the two earpieces from electrocardiogram ECG sensors separately disposed at the two earpieces, wherein each earpiece is provided with at least one ECG sensor.

10. The apparatus of claim 5, wherein each one of the heartbeat transmission signals comprises: a blood flow pulsation waveform.

11. The apparatus of claim 6, wherein each one of the heartbeat transmission signals comprises: a blood flow pulsation waveform.

12. The apparatus of claim 10, wherein the obtaining module is further configured to: obtain blood flow pulsation waveforms at the two earpieces from photoplethysmogram PPG sensors separately disposed at the two earpieces, wherein each earpiece is provided with at least one PGG sensor.

13. The apparatus of claim 5, wherein the apparatus and the two earpieces are disposed in one earphone device.

14. The apparatus of claim 5, wherein the apparatus is disposed in an audio output device providing the signals for the two earpieces.

15. An earphone device, comprising: two earpieces in pair and the apparatus of claim 5.

16. The earphone device of claim 15, further comprising: signal acquisition apparatuses separately disposed in the two earpieces, wherein each earpiece is provided with at least one signal acquisition apparatus, and the at least one signal acquisition apparatus is configured to separately acquire the heartbeat transmission signals.

17. The earphone device of claim 16, wherein the at least one signal acquisition apparatus comprises at least one of:
at least one electrocardiogram ECG sensor or at least one photoplethysmogram PPG sensor.

18. A computer readable storage device comprising executable instructions that, in response to execution, cause a device comprising a processor to perform operations, comprising:
obtaining heartbeat transmission signals at two earpieces in pair; and
configuring a sound channel for signals of the two earpieces at least according to the heartbeat transmission signals at the two earpieces.

19. The computer readable storage device of claim 18, wherein the heartbeat transmission signals respectively comprise at least one of an electrocardiographic waveform or a blood flow pulsation waveform.

20. The computer readable storage device of claim 18, wherein the configuring the sound channel for the signals comprises:
comparing the heartbeat transmission signals at the two earpieces, configuring a first sound channel of a first signal of an earpiece corresponding to a first heartbeat transmission signals whose crest appears earlier in a same signal period as a left sound channel, and configuring a second sound channel of another signal of another earpiece corresponding to a second heartbeat transmission signal whose crest appears later in a same signal period as a right sound channel.
